(19) United States
(12) Patent Application Publication
(10) Pub. No.: US 2016/0326053 A1
(43) Pub. Date: Nov. 10, 2016

(54) GROUND IMPROVEMENT MATERIAL, AGGREGATE FOR ASPHALT CONCRETE AND METHOD OF MANUFACTURING THE SAMES

(71) Applicants: Kab Boo KIM, Seoul (KR); Yoon Jung CHOI, Seongnam-si (KR)

(72) Inventors: Kab Boo KIM, Seoul (KR); Yoon Jung CHOI, Seongnam-si (KR)

(21) Appl. No.: 15/034,976

(22) PCT Filed: Nov. 3, 2014
(86) PCT No.: PCT/KR2014/010459

§ 371 Date: May 6, 2016

(30) Foreign Application Priority Data
Nov. 8, 2013 (KR) 10-2013-0135851

(51) Int. Cl. C04B 14/36; C04B 26/26

(52) U.S. Cl. CPC C04B 14/361; C04B 26/26

(57) ABSTRACT

Disclosed are a ground improvement material, an aggregate for asphalt concrete and a method of manufacturing the same. According to an aspect of the present invention, there is provided a ground improvement material containing soil that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil, a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value is less than 0.4.

### TECHNICAL FIELD

The present invention relates to a ground improvement material, an aggregate for asphalt concrete and a method of manufacturing the same, and more particularly, to a ground improvement material and a method of manufacturing the same capable of improving the strength of the embankment body formed by a replacement method or embankment by changing the particle diameter distribution of sand.

Further, the present invention relates to a ground improvement material and a method of manufacturing the same capable of improving the strength of the asphalt concrete by changing the particle diameter distribution of the aggregate.

### BACKGROUND ART

When constructing structures such as roads, bridges and buildings on the ground, they should have sufficient support force as the foundation ground of the structure. In the case of soft ground that does not have a sufficient support force, there is a need for improvement, and there is a method of replacing the soft ground with a high quality of soil using the improvement method.

Further, even in the case of performing the embankment construction work in order to adjust the altitude of the embankment, the road construction and the buildings, the embankment body is formed by filling the high quality of soil.

In this way, although the high quality of soil is filled in the method of replacing the soft ground and in the embankment construction, the strength of the embankment body varies depending on the particle diameter distribution of the particles constituting the soil used for embankment.

Therefore, it is necessary to adjust the particle diameter distribution of the soil in order to promote the strength of the embankment body, which is formed by the replacement method and embankments.

Meanwhile, the aggregate is mixed with concrete or asphalt concrete for the strength enhancement, and it is also necessary to adjust the particle diameter distribution of the aggregate in order to form a stronger concrete.

### DISCLOSURE

### Technical Problem

An embodiment of the present invention is directed to provide a ground improvement material and a method for manufacturing the same improving the strength of the embankment body formed by the replacement method or embankments, by changing the particle diameter distribution of the soil.

Moreover, another embodiment of the present invention is directed to provide an aggregate for asphalt concrete and a method for manufacturing the same capable of improving the strength of the concrete and asphalt concrete by changing the particle diameter distribution of the aggregate.

### Technical Solution

According to an aspect of the present invention, there is provided a ground improvement material containing soil that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil, a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value is less than 0.4.

The soil may have a particle diameter distribution so that the grain size accumulation curve does not intersect above a center of a straight line that connects the accumulative passage rate corresponding to the Dₘᵢₙ value and the accumulative passage rate corresponding to the Dₘₐₓ value.

According to a second aspect of the present invention, there is provided a method for manufacturing a ground improvement material, the method including: a step of calculating an average particle diameter of first soil through the particle diameter analysis of first soil; a step of calculating an average particle diameter of second soil through the particle diameter analysis of second soil; a step of mixing the first soil and the second soil to form a third soil when a difference between an average particle diameter of the first soil and an average particle diameter of the second soil is equal to or greater than 10%; and a step of calculating a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value, when a grain size accumulation curve of the third soil is created through the particle diameter analysis of the third aggregate, a particle diameter of the largest particle is defined as Dₘₐₓ and a particle diameter of the smallest particle is defined as Dₘᵢₙ on a grain size accumulation curve, and selecting the particle as a ground improvement material when the value is less than 0.4.

The third soil may have a particle diameter distribution so that the grain size accumulation curve does not intersect above a center of a straight line that connects the accumulative passage rate corresponding to the Dₘₐₓ value and the accumulative passage rate corresponding to the Dₘᵢₙ value.

According to a third aspect of the present invention, there is provided an aggregate for concrete containing aggregate as an aggregate mixed with concrete that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil, a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐx value is less than 0.04.

The aggregate may have a particle diameter distribution so that the grain size accumulation curve does not intersect above a center of a straight line that connects the accumulative passage rate corresponding to the Dₘᵢₙ value and the accumulative passage rate corresponding to the Dₘₐₓ value.

According to a fourth aspect of the present invention, there is provided a method for manufacturing an aggregate for concrete, the method including: a step of calculating an average particle diameter of first soil through the particle diameter analysis of first soil; a step of calculating an average particle diameter of second soil through the particle diameter analysis of second soil; a step of mixing the first soil and the second soil to form a third soil when a difference between an average particle diameter of the first soil and an average particle diameter of the second soil is equal to or greater than 10%; and a step of calculating a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value, when a grain size accumulation curve of the third aggregate is created through the particle diameter analysis of the third aggregate, a particle diameter of the largest particle is defined as Dₘₐₓ and a particle diameter of the smallest particle is defined as Dₘᵢₙ on a grain size accumulation curve, and selecting the particle as a ground improvement material when the value is less than 0.04.

The third aggregate may have a particle diameter distribution so that the grain size accumulation curve does not intersect above a center of a straight line that connects the accumulative passage rate corresponding to the Dₘₐₓ value and the accumulative passage rate corresponding to the Dₘᵢₙ value.

According to a fifth aspect of the present invention, there is provided an aggregate for asphalt concrete containing an aggregate as an aggregate mixed with an asphalt that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil, a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value is less than 0.4.

The aggregate for asphalt concrete may have a particle diameter distribution so that the grain size accumulation curve does not intersect above a center of a straight line that connects the accumulative passage rate corresponding to the Dₘₐₓ value and the accumulative passage rate corresponding to the Dₘᵢₙ value.

According to a sixth aspect of the present invention, there is provided as a method for manufacturing an aggregate for asphalt concrete, the method including: a step of calculating an average particle diameter of a first aggregate through the particle diameter analysis of the first aggregate; a step of calculating an average particle diameter of a second aggregate through the particle diameter analysis of the second aggregate; a step of mixing the first aggregate and the second aggregate to form a third aggregate when a difference between an average particle diameter of the first aggregate and an average particle diameter of the second aggregate is equal to or greater than 10%; and a step of calculating a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value, when a grain size accumulation curve of the third aggregate is created through the particle diameter analysis of the third aggregate, a particle diameter of the largest particle is defined as Dₘₐₓ and a particle diameter of the smallest particle is defined as Dₘᵢₙ on a grain size accumulation curve, and selecting the particle as a ground improvement material when the value is less than 0.4.

The third aggregate may have a particle diameter distribution so that the grain size accumulation curve does not intersect above a center of a straight line that connects the accumulative passage rate corresponding to the Dₘₐₓ value and the accumulative passage rate corresponding to the Dₘᵢₙ value.

It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### Advantageous Effects

According to an embodiment of the present invention, it is possible to enhance the strength of the embankment body formed by the replacement method or embankments by changing the particle diameter distribution of the soil.

Moreover, it is possible to enhance the strength of concrete and asphalt concrete by changing the particle diameter distribution of the aggregate.

### DESCRIPTION OF DRAWINGS

FIG. 1 is a perspective view for explaining a particle array of a ground improvement material according to an embodiment of the present invention.

FIG. 2 is a diagram for explaining the array of the ground improvement material according to an embodiment of the present invention.

FIG. 3 is a diagram for explaining a configuration principle of the ground improvement material according to an embodiment of the present invention.

FIGS. 4 and 5 are diagrams for explaining a probability calculation method of the gain array of the improvement material according to an embodiment of the present invention.

FIG. 6 is a diagram illustrating a grain size accumulation curve of the ground improvement material according to an embodiment of the present invention.

FIG. 7 is a diagram illustrating various grain size accumulation curve of the soil used in the ground improvement material.

FIG. 8 is a flowchart of a method for manufacturing the ground improvement material according to another embodiment of the present invention.

FIG. 9 is a diagram illustrating the distribution of the aggregate in concrete.

FIG. 10 is a diagram illustrating the aggregate distribution in asphalt concrete.

### MODE FOR INVENTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, embodiments of a ground improvement material, an aggregate for asphalt concrete and a manufacturing method thereof according to the present invention will be described in detail with reference to the accompanying drawings, and the same or corresponding components in describing with reference to the accompanying drawings should be denoted by the same reference numbers, and its repeated description will not be provided.

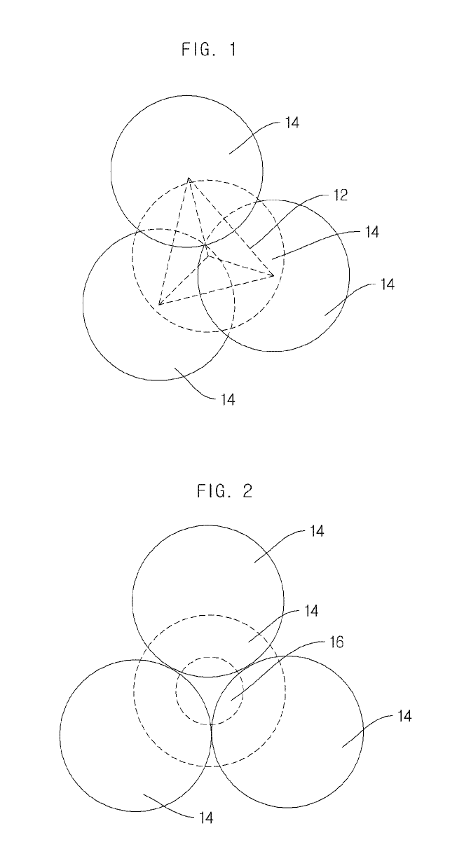

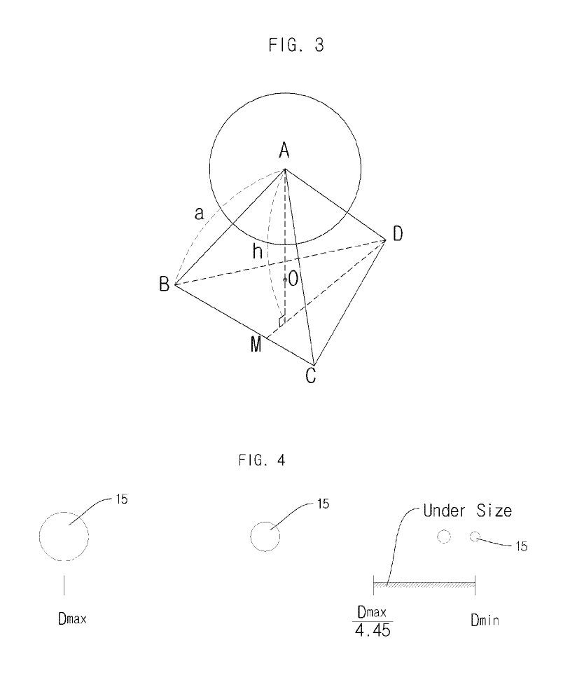

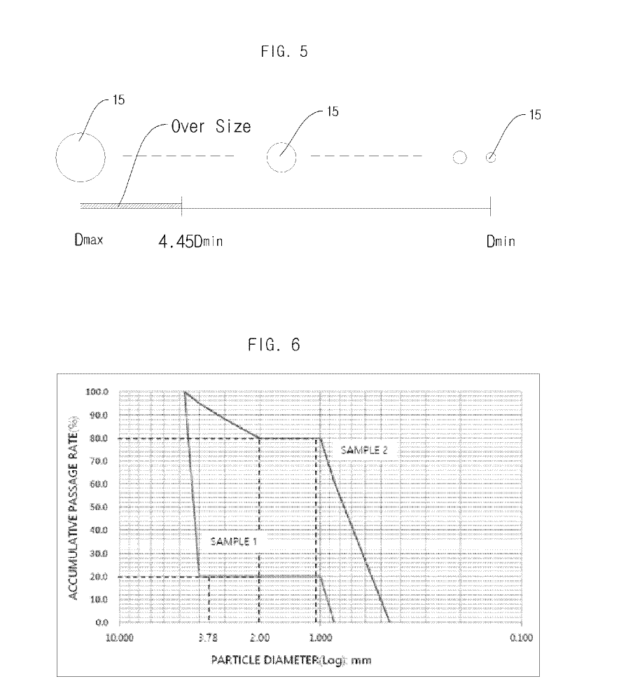

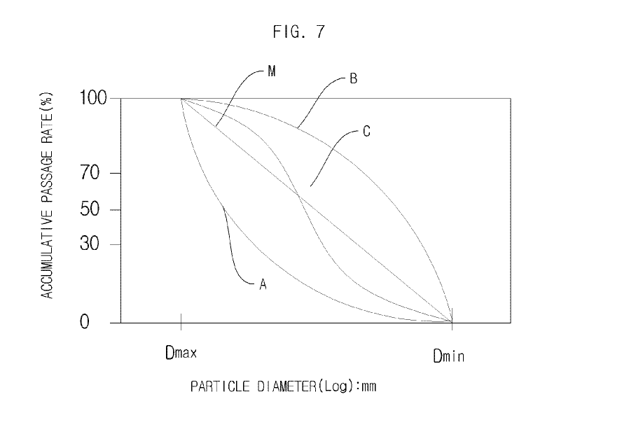

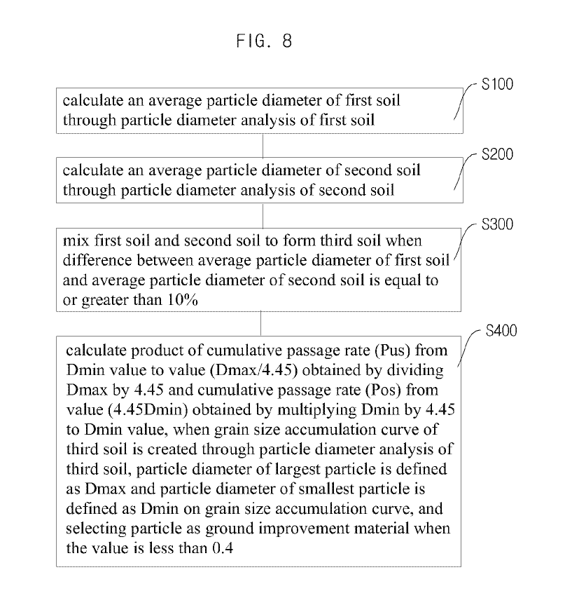

FIG. 1 is a perspective view for explaining a particle array of a ground improvement material according to an embodiment of the present invention. FIG. 2 is a diagram for explaining the array of the ground improvement material according to an embodiment of the present invention. FIG. 3 is a diagram for explaining a configuration principle of the ground improvement material according to an embodiment of the present invention. FIGS. 4 and 5 are diagrams for explaining a probability calculation method of the gain array of the improvement material according to an embodiment of the present invention. FIG. 6 is a diagram illustrating a grain size accumulation curve of the ground improvement material according to an embodiment of the present invention. FIG. 7 is a diagram illustrating various grain size accumulation curve of the soil used in the ground improvement material.

FIGS. 1 to 7 illustrate a regular tetrahedron 12, a large particle 14, a particle 15 and a small particle 16.

The ground improvement material according to the present embodiment contains a soil that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil, a product of an accumulative passage rate (Pₒₛ) from a value obtained by multiplying Dₘᵢₙ by 4.45 to the Dₘₐₓ value and an accumulative passage rate (Pᵤₛ) from Dₘᵢₙ value to a value obtained by dividing Dₘₐₓ by 4.45 is less than 0.4. Such a ground improvement material can improve the strength of the embankment body formed by the replacement method or embankments, by changing the particle diameter distribution of the soil.

The ground improvement material consisting of soil can be used in the method for replacing the soft ground or in the embankment construction work. Here, the concept of the ground improvement material means is a concept including soil with enhanced strength and means the soil that is used to promote the strength of the ground such as substitution materials of soft ground, embankment materials of the embankment construction, and a refilling material.

Determination of the strength of the embankment body formed by filling the soil is to very rigidly harden the soil. As the hardening becomes better, the strength is enhanced and the unit weight also increases.

Major constituents of the strength of the embankment body formed by filling the soil may be made up of friction (sliding) resistance between the particles 15 constituting the soil, and interlocking resistance due to meshing between the particles 15.

When the particles 15 constituting the soil are assumed to be a sphere of the same size, it is possible to understand that soil maintains the stable state in a case where the particles 15 of soil make a regular polyhedron array.

The array of the most stable particles in the regular polyhedron array 15 is a form in which the large particles 14 make an array of the rectangular tetrahedron 12 with the smallest number of triangle, while making a triangle so that the outer peripheries are in contact with each other, as shown in FIG. 1.

However, the soil is an assembly of particles 15 having a variety of particle diameters, and in order that the different particle diameters of the particles 15 make a predetermined array to maximize the friction (sliding) resistance between the particles 15 and the interlocking resistance due to meshing between the particles 15, it can be seen as a state in which still another small particle 16 is disposed between the large particles 14 constituting the regular polyhedron array is arranged, and the small particles 16 are disposed in contact with the outer peripheries of the large particles 14 constituting the regular polyhedron array.

That is, in the case of the array of the regular tetrahedron that is an array of the most stable particles in the regular polyhedron array 12, as shown in FIGS. 1 and 2, this array is a form (hereinafter, referred to as a “regular tetrahedron array”) in which the large particles 14 make an array of the rectangular tetrahedron 12 with the smallest number of triangle, while making a triangle so that the outer peripheries are in contact with each other, and the small particles 16 are arranged between the four large particles 14 making the array of regular tetrahedron so that the small particles 16 are in contact with the outer peripheries of the large particles 14. That is, this is a form in which the center of the large particle 14 is located at the four vertices of the regular tetrahedron 12 so that their outer peripheries are in contact with each other, and the small particle 16 in contact with the outer periphery of the large particle 14 is disposed between the large particles 14 located at the four vertices 14. When the particles of the soil make an array, while the contact force between the large particles 14 constituting the regular tetrahedron 12 and the small particle 16 disposed therebetween is maximized, the friction (sliding) resistance and the interlocking resistance caused by meshing between the particles 15 are maximized, and the strength of the soil is enhanced.

A particle diameter ratio of the large particles 14 constituting an array of the regular tetrahedron 12 and the small particle 16 disposed therebetween can be calculated as follows.

Referring to FIGS. 3 and 4, when a length of one side of the tetrahedral 12 is defined as “a”, a radius of the large particle 14 is defined as “R”, and a radius of the small particle 16 is defined as “r”,

The radius R of the large particle 14 is as follows:

$$R = \frac{a}{2}$$

and

The height h of the regular tetrahedron 12 is as follows:

$$h = \frac{\sqrt{6}}{3} a$$

A distance AO from the vertex A of the regular tetrahedron 12 to the center of gravity O is as follows:

$$\begin{matrix}\begin{matrix}\overline{AO} = \frac{3}{4} h \\ = \frac{3}{4} \cdot \frac{\sqrt{6}}{3} a \\ = \frac{\sqrt{6 }}{4} a\end{matrix} & \\ and , & \end{matrix}$$

The radius r of the small particle 16 is as follows:

$$\begin{matrix}r = \overline{AO} - \frac{a}{2} \\ = \frac{\sqrt{6}}{4} a - \frac{a}{2} \\ = \frac{\sqrt{6} - 2}{4} a\end{matrix}$$

Therefore, the particle diameter ratio (R/r) between the large particle 14 and the small particles 16 can be calculated in the following [Formula 1].

$$\frac{R}{r} = \frac{\frac{a}{2}}{\frac{\sqrt{6} - 2}{4} a} \approx 4.45 \qquad [ Formula 1 ]$$

In order to obtain soil with ideally enhanced resistance force, it is desirable to constitute the soil to have the above-mentioned particle diameter ratio. However, since the particle 15 of soil may not be a perfect sphere and the soil is a collection of particles 15 having various particle diameters, it is difficult to make up the ideal soil as described above. However, there is a need to adjust the particle diameter of the soil to increase the probability in which the large particle 14 makes up an array of the regular tetrahedron 12 and the small particle 16 can be disposed therebetween.

FIG. 4 is a diagram for explaining a case of adjusting the particle diameter distribution based on the large particle 14, and FIG. 5 is a diagram for explaining a case of adjusting the particle diameter distribution based on the small particle 16.

FIGS. 4 and 5 schematically illustrate a configuration in which the particles 15 are placed so that the particle diameter size increases from the right to left direction of the horizontal segments when assuming that the particles 15 constituting the soil are placed in the order of the particle diameter sizes.

Referring to FIG. 4, on the basis of the particle 15 having the largest particle diameter Dₘₐₓ, the particles 15 having a particle diameter from Dₘₐₓ/4.45 to Dₘᵢₙ by the particle diameter ratio (R/r) 4.45 are small particles (hereinafter, referred to as an “under-size”) which fail to be in contact with the outer peripheries of four large particles 14 constituting the regular tetrahedron 12, and mean a particle diameter which is larger than the particle diameter ratio 4.45 and may not maintain a stable array of the regular tetrahedron array body.

Further, referring to FIG. 5, on the basis of the particle 15 having the smallest particle diameter Dₘᵢₙ, the particles 15 having a particle diameter from 4.45Dₘᵢₙ to Dₘₐₓ by the particle diameter ratio (R/r) 4.45 are large particles (hereinafter, referred to as an “over-size”) which fail to be in contact with the outer peripheries of the small particle, and mean a particle diameter which is larger than the particle diameter ratio 4.45 and may not maintain a stable array of the regular tetrahedron array body.

When the probability of becoming the under-size is defined as Pᵤₛ, the average probability of becoming the under-size to the whole particle diameter on the basis of the large particle 14 is Pᵤₛ/2, and when the probability of becoming the over-size is defined as Pₒₛ, the average probability of becoming the over-size to the whole particle diameter on the basis of the small particle 16 is Pₒₛ/2.

Therefore, the probability Pₒ of becoming larger than the particle diameter ratio 4.45 for making up the regular tetrahedron array body is as follows [Formula 2].

$${P}_{o} = \frac{{P}_{us}}{2} \cdot \frac{{P}_{os}}{2} = \frac{{P}_{us} \cdot {P}_{os}}{4} \qquad [ Formula 2 ]$$

Usually, when applying 90% as a reasonable reliable level and substituting a significance level 10% corresponding thereto, the following relation is established.

$$\frac{{P}_{us} \cdot {P}_{os}}{4} = 0.1 and , \\ {P}_{us} \cdot {P}_{os} = 0.4$$

Therefore, in order that the particles 15 of soil maintain a stable array of the regular tetrahedron array body, Dₘₐₓ of the maximum particle diameter and Dₘᵢₙ of the smallest particle are set be a particle diameter that satisfies [Formula 3] below.

Pᵤₛ·Pₒₛ≦0.4 [Formula 3]

Meanwhile, by analyzing the particle diameter distribution of the particles 15 contained in the soil, the particle diameter of the particle 15 is taken as a logarithmic scale on a horizontal axis and a weight percentage passing through the particle diameter is taken as a common scale on vertical axis to draw a particle diameter distribution of the soil, which is called a grain size accumulation curve.

In the grain size accumulation curve, the probability Pᵤₛ of becoming the under-size can be expressed by an accumulative passage rate (%) from the Dₘᵢₙ value to a value (Dₘₐₓ/4.45) obtained by dividing Dₘₐₓ by 4.45, and the probability Pₒₛ of becoming the over-size can be expressed by an accumulative passage rate (%) from a value (4.45Dₘᵢₙ) obtained by multiplying Dₘᵢₙ by 4.45 to the Dₘₐₓ value.

That is, according to [Formula 3], in the case of the soil that satisfies the condition in which a product of the cumulative passage rate (Pₒₛ) from the value (4.45Dₘᵢₙ) obtained by multiplying Dₘᵢₙ by 4.45 to the Dₘₐₓ value and the cumulative passage rate (Pᵤₛ) from the Dₘᵢₙ value to a value (Dₘₐₓ/4.45) obtained by dividing Dₘₐₓ by 4.45 is less than 0.4, it is possible to understand that the particles 15 making up the soil are highly likely to maintain a stable array of the regular tetrahedron array body with a high probability and have a high strength.

Here, the accumulative passage rate means a value obtained by subtracting the smaller value from the larger value after calculating each of the accumulative passage rates corresponding to Dₘᵢₙ, Dₘₐₓ, Dₘₐₓ/4.45 and 4.45Dₘᵢₙ values. For reference, the cumulative passage rate corresponding to the Dₘₐₓ value is 100%, and the cumulative passage rate corresponding to the Dₘᵢₙ value is 0%.

FIG. 6 illustrates the grain size accumulation curve of two samples according to [Table] 1 below, sample 1 shows a grain size accumulation curve of the soil having a particle diameter distribution from 0.85 mm to 4.75 mm, and sample 2 shows a grain size accumulation curve of the soil having a particle diameter distribution from 0.45 mm to 4.75 mm.

First, when checking whether sample 1 satisfies the aforementioned [Formula 3],

$${D}_{m ax} = 4.75$$

$${D}_{m i n} = 0.85$$

$$4.45 \cdot {D}_{m i n} = 4.45 \times 0.85 \approx 3.78$$

$$\frac{{D}_{ma x}}{4.45} = \frac{4.75}{4.45} \approx 1.07$$

In the grain size accumulation curve of sample 1 of FIG. 6, the cumulative passage rate corresponding to 4.45Dₘᵢₙ=3.78 is 20%, and the cumulative passage rate corresponding to the Dₘₐₓ=4.75 is 100%. Thus, the accumulative passage rate (Pₒₛ) from 4.45Dₘᵢₙ=3.78 to Dₘₐₓ=4.75 is 80%. Further, the cumulative passage rate corresponding to Dₘᵢₙ=0.85 is 0%, and the cumulative passage rate corresponding to Dₘₐₓ/4.45=1.07 is 20%. Thus, the cumulative passage rate (Pᵤₛ) from Dₘᵢₙ=0.85 to Dₘₐₓ/4.45=1.07 is 20%.

Therefore, the following relation is established.

Pᵤₛ·Pₒₛ=0.8×0.2=0.16≦0.4

The above [Formula 3] is satisfied.

Also, when checking whether sample 2 satisfies the aforementioned [Formula 3],

$${D}_{m ax} = 4.75$$

$${D}_{m i n} = 0.45$$

$$4.45 \cdot {D}_{m i n} = 4.45 \times 0.45 \approx 2.00$$

$$\frac{{D}_{ma x}}{4.45} = \frac{4.75}{4.45} \approx 1.07$$

In the grain size accumulation curve of the sample 2 in FIG. 6, the cumulative passage rate corresponding to 4.45Dₘᵢₙ=2.00 is 80%, and the cumulative passage rate corresponding to the Dₘₐₓ=4.75 is 100%. Thus, the accumulative passage rate (Pₒₛ) from 4.45Dₘᵢₙ=2.0 to Dₘₐₓ=4.75 is 20%. Further, the cumulative passage rate corresponding to Dₘᵢₙ=0.45 is 0%, and the cumulative passage rate corresponding to Dₘₐₓ/4.45=1.07 is 80%. Thus, the cumulative passage rate (Pᵤₛ) from Dₘᵢₙ=0.45 to Dₘₐₓ/4.45=1.07 is 80%.

Therefore, the following relation is established.

Pᵤₛ·Pₒₛ=0.2×0.8=0.16≦0.4

The above [Formula 3] is satisfied.

TABLE 1

| | particle diameter | shear resistance angle (φ)(deg) | | |
|---|---|---|---|---|
| | distribution range (mm) | primary | secondary | average |
| Sample 1 | 0.85 to 4.75 | 55.9 | 60.1 | 58.0 |
| Sample 2 | 0.45 to 4.75 | 42.7 | 48.6 | 45.6 |

[Table 1] shows the shear resistance angle determined through the shear resistance test of samples 1 and 2. The shear resistance tests of each sample were performed twice, and as a result of the two shear resistance tests, the average shear resistance angle (φ) of sample 1 is a 58.0° (deg), and the average shear resistance angle (φ) of the sample 2 is 45.6° (deg).

The shear resistance angle of soil having the ordinary particle diameter distribution was performed by the conventional many studies. According to the shear resistance angle measurement test of the intermediate sand performed by Holz and Gibbs in 1956, it was found that it was possible to obtain a shear resistance angle higher than 36 to 40° (deg) of the shear resistance angle of “intermediate sand finely hardened halfway having good particle diameter distribution of angular particles” in samples 1 and 2.

In general, the shear resistance angle (φ) is related to the supporting force of the soil, and as the shear resistance angle is great, it represents the high supporting force.

Thus, as long as the particle diameter of the particle 15 constituting the soil is adjusted to maintain a stable array of regular tetrahedron array body with high probability of becoming the particles 15 of soil, it is possible to manufacture a ground improvement material of high strength.

Meanwhile, FIG. 7 illustrates grain size accumulation curves of various forms. In order that the particles 15 of soil maintain a stable array of regular tetrahedron array body with higher probability, it is preferable to have a particle diameter distribution in which the grain size accumulation curve of soil does not intersect above a center of a straight line M that connects the cumulative passage rate corresponding to the largest particle diameter Dₘₐₓ value and the cumulative passage rate corresponding to the smallest particle diameter Dₘᵢₙ value.

Here, the center of the straight line means the cumulative passage of means 50% cumulative pass rate, and it is preferable to have a particle diameter distribution in which the grain size accumulation curve of soil does not intersect in the portion 50% or more of the straight line M that connects the accumulative passage rate corresponding to the largest particle diameter Dₘₐₓ value and the accumulative passage rate corresponding to the smallest particle diameter Dₘᵢₙ value.

Referring to FIG. 7, since the curves A and B do not intersect with the straight line M, the particles of soil are highly likely to maintain a stable array of the regular tetrahedron array body. In contrast, the curve C intersects above the center the straight line M, and it is possible to understand that the particles of soil are less likely to maintain a stable array of regular tetrahedron array body.

A method for mixing the sand and manufacturing a ground improvement material will be described based on the foregoing description. First, the average particle diameter of the first soil is calculated via the particle diameter analysis of the first soil (S100). The ground improvement material according to the present embodiment is prepared by mixing two types of soil with the different particle diameter from each other, and the average particle diameter of the first soil is first calculated through the particle diameter analysis of the first soil. In the method for calculating the average particle diameter, the particle diameter analysis of the first soil is performed to create a grain size accumulation curve, and a particle diameter with the accumulative passage rate corresponding to 50% is calculated as the average particle diameter.

Next, an average particle diameter of the second soil is calculated through the particle diameter analysis of the second soil (S200). Similarly to the above procedure, the average particle diameter of the second soil is calculated through the particle diameter analysis of the second soil, the particle diameter analysis of the second soil is performed to create a grain size accumulation curve, and the particle diameter with the cumulative passage rate corresponding to 50% is calculated as an average particle diameter.

Next, when a difference between the average particle diameter of the first soil and the average particle diameter of the second soil is 10% or more, a third soil is formed by mixing the first soil and the second soil. As shown in FIG. 7, in order that the particles 15 of soil maintain a stable array of the regular tetrahedron array body with higher probability, it is preferable to have a particle diameter distribution in which the grain size accumulation curve of the third mixed soil does not intersect above a center of a straight line M that connects the accumulative passage rate corresponding to the largest particle diameter Dₘₐₓ value and the accumulative passage rate corresponding to the smallest particle diameter Dₘᵢₙ value. In this case, when mixing the soil in which the difference between the average particle diameter of the first soil and the average particle diameter of the second soil is 10% or more, the grain size accumulation curve is less likely intersect with each other above the center of the straight line M.

Next, a grain size accumulation curve of the third soil is created through the particle diameter analysis of the third soil, and when a particle diameter of the largest particle is defined as Dₘₐₓ and a particle diameter of the smallest particle is defined as Dₘᵢₙ on a grain size accumulation curve, by calculating a product of an accumulative passage rate (Pᵤₛ) from the Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value, when its value is less than 0.4, it is selected as the ground improvement material.

Even when mixing the soil with 10% a difference in average particle diameter between the first soil and the second soil, the particles of third soil 15 do not have a particle diameter distribution for maintaining a stable array of regular tetrahedron array body. Therefore, by calculating the product of the cumulative passage rate (Pᵤₛ) from the Dₘᵢₙ value to the value (Dₘₐₓ/4.45) obtained by dividing the Dₘₐₓ by 4.45 and the cumulative passage rate (Pₒₛ) from a value (4.45Dₘᵢₙ) obtained by multiplying Dₘᵢₙ by 4.45 to the Dₘₐₓ value, it is checked whether the calculated product satisfies the above-mentioned [Formula 3]. When the product satisfies the above-mentioned [Formula 3], the soil is selected as a ground improvement material, and when not satisfying the above-mentioned [Formula 3], the soil is re-mixed with other soil to perform the aforementioned procedures.

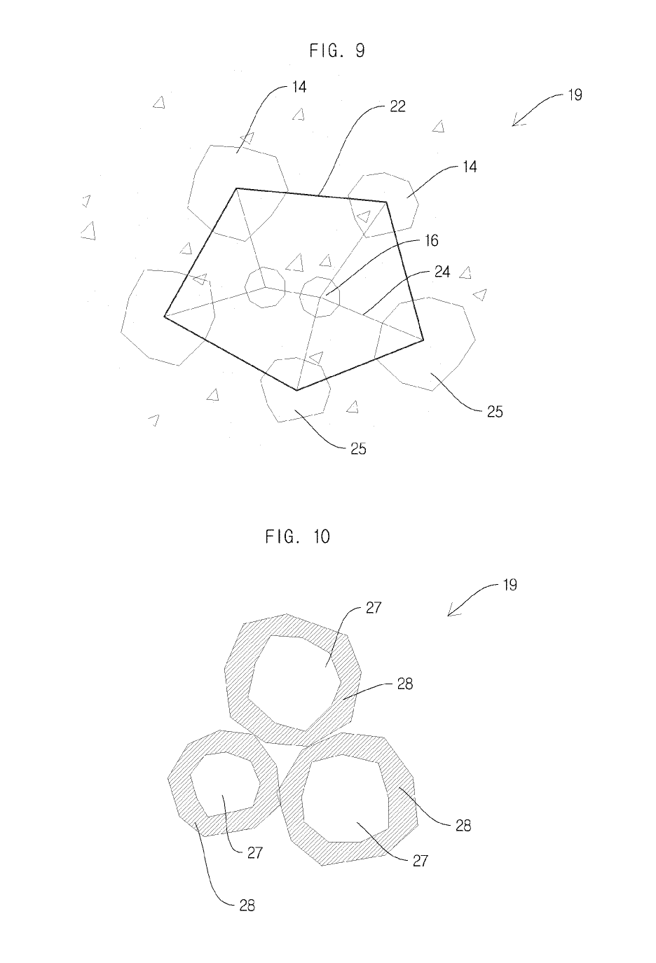

FIG. 9 is a diagram illustrating the distribution of the aggregate in the concrete. FIG. 9 illustrates a large particle 14, a small particle 16, a concrete 19, a cement mortar 20, a large contact force 22, a small contact force 24 and an aggregate 25.

The aggregate for concrete 25 according to the present embodiment is an aggregate 25 mixed into the concrete 19, and includes the soil 25 that satisfies a condition in which, when a particle diameter of the largest particle 14 is defined as Dₘₐₓ and a particle diameter of the smallest particle 16 is defined as Dₘᵢₙ on a grain size accumulation curve created through a particle diameter analysis of the soil 25, a product of the cumulative passage rate (Pᵤₛ) from the Dₘᵢₙ value to the value (Dₘₐₓ/4.45) obtained by dividing Dₘₐₓ by 4.45 and an accumulative passage rate (Pₒₛ) from the value (4.45Dₘᵢₙ) obtained by multiplying Dₘᵢₙ by 4.45 to the Dₘₐₓ value is less than 0.04. Such an aggregate for concrete 25 may improve the strength of the concrete 19 by changing the particle diameter distribution of the aggregate 25.

The concrete 19 is formed by blending fine aggregates, coarse aggregates 25, water and the like with cement at an appropriate ratio. Among them, the coarse aggregates 25 are defined as large particles 14 of 4.75 mm or more. Among them, the fine aggregates such as sand are mixed cement and water to form a cement mortar 20, and the aggregate 25 for concrete according to the present embodiment can be applied to the common coarse aggregate 25.

In general, the aggregate is mixed up to one to six times the cement 25, and the shape and the filling properties of the aggregate 25 have a significant impact on the strength. However, conventionally, it was determined that, in the adjustment of strength of the concrete 19, the adhesion between the cement and the aggregates 25 dominates the strength, and there was an attempt to increase the amount of cement or enhance the strength of the concrete 19 using a high-strength cement.

The present invention is related to enhancement of the strength of concrete 19 by adjusting the particle diameter distribution of the aggregate 25, unlike the conventional methods.

Since the aggregate 25 mostly bears the stiffness of the concrete 19, when a force is applied from the outside, a force (stress) is concentrated on the aggregate 25. When the force is efficiently concentrated on the aggregate 25 having great stiffness in consideration of the flow of the force (stress), it is possible to obtain the concrete 19 of greater stiffness by the same amount of cement.

While the force is concentrated on the large aggregate 25 of the great stiffness, motion is generated to the side of weak stiffness, and the contact forces 22 and 24 in the concrete 19 are transmitted to the adjacent aggregate 25 or are transmitted to the cement mortar 20. As shown in FIG. 9, when increasing a frequency in which particles 14 of great stiffness come into contact with the great contact force 22, or increasing a frequency in which the small particles 16 and the large particles 14 come into contact with the small contact force 24, a very strong concrete 19 can be obtained.

Based on the same principle as the ground improvement material according to an embodiment described above, when the particles constituting the aggregate 25 are assumed to be in the form of a sphere having the same size, it is possible to obtain a strong concrete 19 when the particles of aggregate 25 ideally make up a regular polyhedron array.

The array of the most stable particles in the regular polyhedron array is in the form of making up the array of the polyhedron in which the number of the triangles is the smallest, while making up a triangle so that the outer circumferences of the particles come into contact with each other (see FIG. 1).

However, the aggregate 25 is made up of particles having different particle diameters. In order that the particles of the different particle diameters make up a constant array to maximize the friction (sliding) resistance between the particles and the interlocking resistance between the particles, other particles are disposed between the particles constituting the regular polyhedron array, and the particles are in a state of being in contact with the outer periphery of the particles constituting the regular polyhedron array.

For example, in the case of an array of the regular tetrahedron that is an array of the most stable particles, this is in the form (hereinafter, referred to as a “regular tetrahedron array body”) in which, while the large particles 14 make up a triangle so that outer peripheries come into contact with each other, it makes up an array of the smallest number of triangles, and the small particle 16 in which the outer periphery comes into contact with this are arranged between the four large particles 14 making up the array of a regular tetrahedron. That is, this is a form in which the center of the large particle 14 is located on the four vertices of the regular tetrahedron so that outer peripheries come into contact with each other, and the small particle 16 coming into contact with the outer periphery of the large particle 14 is disposed between the large particles 14 located on the four vertices. When the particles of aggregate 25 make up an array in this way, while the contact force between the large particles 14 constituting the regular tetrahedron and the small particle 16 disposed therebetween is maximized, the friction (sliding) resistance and the interlocking resistance due to meshing between the particles are maximized to induce a large contact force in the cement mortar 20 and to greatly improve the strength of concrete 19.

When the radius of the large particles 14 constituting the aggregate 25 is defined as R and the radius of the small particle 16 is defined as r, a particle diameter ratio (R/r) of the large particles 14 constituting an array of the regular tetrahedron and the smaller particle 16 disposed therebetween is as the following [Formula 4] in the same manner as described above.

$$\frac{R}{r} = 4.45 \qquad [ Formula 4 ]$$

To ideally obtain an array of the aggregate 25 with a strong contact force in the cement mortar 20, it is desirable to constitute the aggregates 25 to have the aforementioned particle diameter ratio. However, since the particles of the aggregate 25 may not be a perfect sphere and is a collection of particles 15 having various particle diameters, it is difficult to make up the ideal aggregate 25 as described above. However, there is a need to adjust the particle diameter of the aggregate to increase the probability in which the large particle 14 makes up an array of the regular tetrahedron 12 and the small particle 16 can be disposed therebetween.

Further, on the basis of the particle having the largest particle diameter Dₘₐₓ, the particle having a particle diameter from Dₘₐₓ/4.45 to Dₘᵢₙ by the particle diameter ratio (R/r) 4.45 is a small particle (hereinafter, referred to as an “under-size”) which fails to be in contact with the outer peripheries of four large particles 14 constituting the regular tetrahedron 12, becomes larger than the particle diameter ratio 4.45 and may not maintain a stable array of the regular tetrahedron array body (see FIG. 4).

Further, on the basis of the particle 15 having the smallest particle diameter Dₘᵢₙ, the particle having a particle diameter from 4.45Dₘᵢₙ to Dₘₐₓ by the particle diameter ratio (R/r) 4.45 is a particle (hereinafter, referred to as an “over-size”) which fails to be in contact with the outer periphery of the small particle, becomes larger than the particle diameter ratio 4.45 and may not maintain a stable array of the regular tetrahedron array body.

When the probability of becoming the under-size is defined as Pᵤₛ, the average probability of becoming the under-size to the whole particle diameter on the basis of the large particle 14 is Pᵤₛ/2, and when the probability of becoming the over-size is defined as Pₒₛ, the average probability of becoming the over-size to the whole particle diameter on the basis of the small particle 16 is Pₒₛ/2.

Therefore, the probability Pₒ of becoming larger than the particle diameter ratio 4.45 for making up the regular tetrahedron array body is as follows [Formula 5].

$${P}_{o} = \frac{{P}_{us}}{2} \cdot \frac{{P}_{os}}{2} = \frac{{P}_{us} \cdot {P}_{os}}{4} \qquad [ Formula 5 ]$$

When applying the very strict reliable level 99% in consideration of the aggregate 25 of a loose state in the cement mortar 20 and substituting the significance level 1% corresponding thereto, the following relation is established.

Pᵤₛ·Pₒₛ=0.04

Therefore, in order that the particles of the aggregate 25 in the cement mortar 20 maintains a stable array of the regular tetrahedron array body at a high probability, the particle diameter Dₘₐₓ of the largest particle and the particle diameter Dₘᵢₙ of the smallest particle are set to the particle diameter that satisfies the following [Formula 6].

Pᵤₛ·Pₒₛ≦0.04 [Formula 6]

In the grain size accumulation curve obtained via the particle diameter analysis of the aggregate 25, the possibility Pᵤₛ of becoming the under-size can be represented by the accumulative passage rate (%) from the Dₘᵢₙ value to a value (Dₘₐₓ/4.45) obtained by dividing Dₘₐₓ by 4.45, and the probability Pₒₛ of becoming the over-size can be represented by the accumulative passage rate (%) from the value (4.45Dₘᵢₙ) obtained by multiplying Dₘᵢₙ by 4.45 to the Dₘₐₓ value.

That is, according to [Formula 6], in the case of the aggregate that satisfies the condition in which a product of the cumulative passage rate (Pₒₛ) from the value (4.45Dₘᵢₙ) obtained by multiplying Dₘᵢₙ by 4.45 to the Dₘₐₓ value and the cumulative passage rate (Pᵤₛ) from the Dₘᵢₙ value to a value (Dₘₐₓ/4.45) obtained by dividing Dₘₐₓ by 4.45 is less than 0.04, it is possible to determine that the particles 15 making up the aggregate are highly likely to maintain a stable array of the regular tetrahedron array body with a high probability and to obtain a concrete 19 of high strength.

Based on the forgoing contents, a method for manufacturing the aggregate 25 for concrete by mixing the aggregate 25 having different particle diameters from each other is similar to the method for manufacturing the ground improvement material described above. That is, an average particle diameter of first aggregate is calculated through the particle diameter analysis of first aggregate, and an average particle diameter of second aggregate is calculated through the particle diameter analysis of the second aggregate. The method of calculating the average particle diameter performs the particle diameter analysis of the first aggregate to create a grain size accumulation curve, and a particle diameter having the accumulative passage rate diameter corresponding to 50% is calculated as an average particle diameter. Next, the first aggregate and the second aggregate are mixed to form a third aggregate when a difference between an average particle diameter of the first aggregate and an average particle diameter of the second aggregate is equal to or greater than 10%. In order that the particles 15 of aggregate maintain a stable array of the regular tetrahedron array body with higher probability, it is preferable to have a particle diameter distribution in which the grain size accumulation curve of the mixed third aggregate does not intersect above a center of a straight line M that connects the accumulative passage rate corresponding to the largest particle diameter Dₘₐₓ value and the accumulative passage rate corresponding to the smallest particle diameter Dₘᵢₙ value. In this case, when mixing the aggregates in which the difference between the average particle diameter of the first aggregate and the average particle diameter of the second aggregate is 10% or more, the curves are less likely to intersect with each other above the center of the straight line M. Next, a grain size accumulation curve of the third aggregate is created through the particle diameter analysis of the third aggregate, when a particle diameter of the largest particle is defined as Dₘₐₓ and a particle diameter of the smallest particle is defined as Dₘᵢₙ on the grain size accumulation curve, a product of an accumulative passage rate (Pₒₛ) from a value obtained by multiplying Dₘᵢₙ by 4.45 to the Dₘᵢₙ value and an accumulative passage rate (Pᵤₛ) from Dₘᵢₙ to a value obtained by dividing Dₘₐₓ by 4.45 is calculated, when the value is less than 0.4, it is selected as the aggregate 25 for concrete. When satisfying the [Formula 6], it is selected as the aggregate 25 for concrete, and when not satisfied, it is re-mixed with the other aggregate 25 with the large average particle diameter to perform the aforementioned procedures.

FIG. 10 is a diagram illustrating the aggregate distribution in the asphalt concrete. FIG. 10 illustrates the aggregate 27, the asphalt 28 and the asphalt concrete 26.

The aggregate 27 for asphalt concrete according to the present embodiment is an aggregate 27 mixed with the asphalt 28, and includes the aggregate 27 that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil 27, a product of an accumulative passage rate (Pₒₛ) from the value obtained by multiplying Dₘᵢₙ by 4.45 to the Dₘₐₓ value and the cumulative passage rate (Pᵤₛ) from Dₘᵢₙ to the value obtained by dividing Dₘₐₓ by 4.45 is less than 0.4. Such an aggregate 27 for asphalt concrete may improve the strength of the asphalt concrete 26 by changing the particle diameter distribution of the aggregate 27.

The asphalt concrete 26 is a mixture obtained by binding the aggregate 27 such as sand and gravel with the dissolved asphalt 28, and the asphalt 28 serves as a binder for binding each of the particles of the aggregate 27 and serves a waterproof material for preventing penetration of water into the mixture, and the aggregate 27 is bound with asphalt 28 to serve as a scaffold which reveals the strength of the asphalt concrete 26.

FIG. 10 illustrates a cross-section of the asphalt concrete 26. The aggregate 27 occupies about 90% of the total volume of the asphalt concrete 26, and the remainder consists of the asphalt 28 and the void. The asphalt 28 wraps around the aggregate 27 to couple the surrounding aggregates 27 to each other. Thus, it can be understood that the plastically deformed resistance of the asphalt concrete 26 depends on the intensity due to the internal friction angle (shear resistance angle) of the aggregate 27.

The aggregate 27 of the asphalt concrete 26 is made up of a coarse aggregate 27 and a finefine aggregate 27, and when it is assumed that the particles constituting these aggregates 27 are a sphere of the same size, it is possible to obtain a strong asphalt concrete 26 when the particles of aggregate 27 ideally make up a regular polyhedron array.

The array of the most stable particles in the regular polyhedron array is in the form of making up the array of the regular polyhedron in which the number of the triangles is the smallest, while making up a triangle so that the outer circumferences of the particles come into contact with each other (see FIG. 1).

As described, in the case of an array of the regular tetrahedron that is an array of the most stable particles, this is in the form (hereinafter, referred to as a “regular tetrahedron array body”) in which, while the large particles make up a triangle so that outer peripheries come into contact with each other, it makes up an array of the smallest number of triangles, and the small particle in which the outer periphery comes into contact with this are arranged between the four large particles 14 making up the array of a regular tetrahedron. That is, this is a form in which the center of the large particle is located on the four vertices of the regular tetrahedron so that outer peripheries come into contact with each other, and the small particle coming into contact with the outer periphery of the large particle is disposed between the large particles located on the four vertices. When the particles of aggregate 27 make up an array in this way, while the contact force between the large particles constituting the regular tetrahedron and the small particle disposed therebetween is maximized, the friction (sliding) resistance and the interlocking resistance due to meshing between the particles are maximized to induce a large contact force in the asphalt concrete 26 and to greatly improve the strength.

When the radius of the large particles constituting the aggregate 27 is defined as R and the radius of the small particle is defined as r, a particle diameter ratio (R/r) of the large particles constituting an array of the regular tetrahedron and the smaller particle disposed therebetween is as the following [Formula 7].

$$\frac{R}{r} = 4.45 \qquad [ Formula 7 ]$$

There is a need to adjust the particle diameter of the aggregate 27 to increase the probability in which the large particle makes up an array of the regular tetrahedron and the small particle can be disposed therebetween.

On the basis of the particle having the largest particle diameter Dₘₐₓ, the particle having a particle diameter from Dₘₐₓ/4.45 to Dₘᵢₙ by the particle diameter ratio (R/r) 4.45 is a small particle (hereinafter, referred to as an “under-size”) which fails to be in contact with the outer peripheries of the four large particles 14 constituting the regular tetrahedron, becomes larger than the particle diameter ratio 4.45 and may not maintain a stable array of the regular tetrahedron array body (see FIG. 4). Further, on the basis of the particle having the smallest particle diameter Dₘᵢₙ, the particle having a particle diameter from 4.45Dₘᵢₙ to Dₘₐₓ by the particle diameter ratio (R/r) 4.45 is a particle (hereinafter, referred to as an “over-size”) which fails to be in contact with the outer periphery of the small particle, becomes larger than the particle diameter ratio 4.45 and may not maintain a stable array of the regular tetrahedron array body (see FIG. 5).

When the probability of becoming the under-size is defined as Pᵤₛ, the average probability of becoming the under-size to the whole particle diameter on the basis of the large particle is Pᵤₛ/2, and when the probability of becoming the over-size is defined as Pₒₛ, the average probability of becoming the over-size to the whole particle diameter on the basis of the small particle is Pₒₛ/2.

Therefore, the probability Pₒ of becoming larger than the particle diameter ratio 4.45 for making up the regular tetrahedron array body is as follows [Formula 8].

$${P}_{o} = \frac{{P}_{us}}{2} \cdot \frac{{P}_{os}}{2} = \frac{{P}_{us} \cdot {P}_{os}}{4} \qquad [ Formula 8 ]$$

Since the aggregates 27 in the asphalt concrete 26 are densely arranged enough to occupy about 90% of the total volume, by applying the 90% as a proper reliable level and significant level 10% corresponding thereto, the following relation is established.

Pᵤₛ·Pₒₛ=0.4

Therefore, in order that the particles of the aggregate 27 in the asphalt concrete 26 maintains a stable array of the regular tetrahedron array body at a high probability, the particle diameter Dₘₐₓ of the largest particle and the particle diameter Dₘᵢₙ of the smallest particle are set to the particle diameter that satisfies the following [Formula 9].

Pᵤₛ·Pₒₛ≦0.4 [Formula 9]

Meanwhile, in the grain size accumulation curve obtained via the particle diameter analysis of the aggregate 27 of the asphalt concrete 26, the possibility Pᵤₛ of becoming the under-size can be represented by the accumulative passage rate (%) from the Dₘᵢₙ value to a value (Dₘₐₓ/4.45) obtained by dividing Dₘₐₓ by 4.45, and the probability Pₒₛ of becoming the over-size can be represented by the accumulative passage rate (%) from the value (4.45Dₘᵢₙ) obtained by multiplying Dₘᵢₙ by 4.45 to the Dₘₐₓ value.

That is, according to [Formula 9], in the case of the aggregate 27 that satisfies the condition in which a product of the cumulative passage rate (Pₒₛ) from the value (4.45Dₘᵢₙ) obtained by multiplying Dₘᵢₙ by 4.45 to the Dₘₐₓ value and the cumulative passage rate (Pᵤₛ) from the Dₘᵢₙ value to a value (Dₘₐₓ/4.45) obtained by dividing Dₘₐₓ by 4.45 is less than 0.4, it is possible to determine that the particles making up the aggregate 27 are highly likely to maintain a stable array of the regular tetrahedron array body with a high probability and to obtain an asphalt concrete 26 of high strength.

Based on the forgoing contents, a method for manufacturing the aggregate 25 for the asphalt concrete by mixing the aggregates 27 having different particle diameters from each other is similar to the method for manufacturing the aggregate for concrete. That is, an average particle diameter of the first aggregate is calculated through the particle diameter analysis of the first aggregate, and an average particle diameter of second aggregate is calculated through the particle diameter analysis of the second aggregate. The method of calculating the average particle diameter performs the particle diameter analysis of the first aggregate to create a grain size accumulation curve, and a particle diameter having the accumulative passage rate diameter corresponding to 50% is calculated as an average particle diameter. Next, the first aggregate and the second aggregate are mixed to form a third aggregate when a difference between an average particle diameter of the first aggregate and an average particle diameter of the second aggregate is equal to or greater than 10%. In order that the particles of aggregate maintain a stable array of the regular tetrahedron array body with higher probability, it is preferable to have a particle diameter distribution in which the grain size accumulation curve of the mixed third aggregate does not intersect above a center of a straight line M that connects the accumulative passage rate corresponding to the largest particle diameter Dₘₐₓ value and the accumulative passage rate corresponding to the smallest particle diameter Dₘᵢₙ value. In this case, when mixing the aggregates in which the difference between the average particle diameter of the first aggregate and the average particle diameter of the second aggregate is 10% or more, the curves are less likely to intersect with each other above the center of the straight line M. Next, a grain size accumulation curve of the third aggregate is created through the particle diameter analysis of the third aggregate, when a particle diameter of the largest particle is defined as Dₘₐₓ and a particle diameter of the smallest particle is defined as Dₘᵢₙ on the grain size accumulation curve, a product of an accumulative passage rate (Pₒₛ) from a value obtained by multiplying Dₘᵢₙ by 4.45 to the Dₘᵢₙ value and an accumulative passage rate (Pᵤₛ) from Dₘᵢₙ to a value obtained by dividing Dₘₐₓ by 4.45 is calculated, when the value is less than 0.4, it is selected as the aggregate 27 for asphalt concrete. When satisfying the [Formula 9], it is selected as the aggregate 27 for asphalt concrete, and when not satisfied, it is re-mixed with the other aggregate 275 with the large average particle diameter to perform the aforementioned procedures.

While the present invention has been described with respect to the specific embodiments, it will be apparent to those skilled in the art that various changes and modifications may be made without departing from the spirit and scope of the invention as defined in the following claims.

Many embodiments other than the above-mentioned embodiments are present within the scope of the claims of the present invention.

1. A ground improvement material containing soil that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil, a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value is less than 0.4.

2. The ground improvement material of claim 1, wherein the soil has a particle diameter distribution so that the grain size accumulation curve does not intersect above a center of a straight line that connects the accumulative passage rate corresponding to the Dₘᵢₙ value and the accumulative passage rate corresponding to the Dₘₐₓ value.

3. A method for manufacturing a ground improvement material, the method comprising:
a step of calculating an average particle diameter of a first soil through a particle diameter analysis of the first soil;
a step of calculating an average particle diameter of a second soil through a particle diameter analysis of the second soil;
a step of mixing the first soil and the second soil to form a third soil when a difference between an average particle diameter of the first soil and an average particle diameter of the second soil is equal to or greater than 10%; and
a step of calculating a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value, when a grain size accumulation curve of the third soil is created through the particle diameter analysis of the third aggregate, a particle diameter of the largest particle is defined as Dₘₐₓ and a particle diameter of the smallest particle is defined as Dₘᵢₙ on a grain size accumulation curve, and selecting the particle as a ground improvement material when the value is less than 0.4.

4. The method of claim 3, wherein the third soil has a particle diameter distribution so that the grain size accumulation curve does not intersect above a center of a straight line that connects the accumulative passage rate corresponding to the Dₘₐₓ value and the accumulative passage rate corresponding to the Dₘᵢₙ value.

5. An aggregate for asphalt concrete containing an aggregate as an aggregate mixed with an asphalt that satisfies a condition in which, when a particle diameter of the largest particle is defined as Dₘₐₓ and a particle diameter of the smallest particle is defined as Dₘᵢₙ on a grain size accumulation curve created through a particle diameter analysis of the soil, a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value is less than 0.4.

6. The aggregate for asphalt concrete of claim 5, wherein the aggregate has a particle diameter distribution so that the grain size accumulation curve does not intersect above a center of a straight line that connects the accumulative passage rate corresponding to the Dₘₐₓ value and the accumulative passage rate corresponding to the Dₘᵢₙ value.

7. A method for manufacturing an aggregate for asphalt concrete, the method comprising:
a step of calculating an average particle diameter of a first aggregate through the particle diameter analysis of the first aggregate;
a step of calculating an average particle diameter of a second aggregate through the particle diameter analysis of the second aggregate;
a step of mixing the first aggregate and the second aggregate to form a third aggregate when a difference between an average particle diameter of the first aggregate and an average particle diameter of the second aggregate is equal to or greater than 10%; and
a step of calculating a product of an accumulative passage rate (Pᵤₛ) from a Dₘᵢₙ value to a value (Dₘₐₓ/4.45) obtained by dividing Dₘₐₓ by 4.45 and an accumulative passage rate (Pₒₛ) from a value (4.45Dₘᵢₙ) obtained by multiplying Dₘᵢₙ by 4.45 to the Dₘₐₓ value, when a grain size accumulation curve of the third aggregate is created through the particle diameter analysis of the third aggregate, a particle diameter of the largest particle is defined as Dₘₐₓ and a particle diameter of the smallest particle is defined as Dₘᵢₙ on a grain size accumulation curve, and selecting the particle as an aggregate for asphalt concrete when the value is less than 0.4.

8. The method of claim 7, wherein the third aggregate has a particle diameter distribution so that the grain size accumulation curve does not intersect above a center of a straight line that connects the accumulative passage rate corresponding to the Dₘₐₓ value and the accumulative passage rate corresponding to the Dₘᵢₙ value.
